(19) United States
(12) Patent Application Publication
(10) Pub. No.: US 2006/0182379 A1
(43) Pub. Date: Aug. 17, 2006

(54) Thin-walled antifriction bearings

(76) Inventors: Karl-Ludwig Grell, Aurachtal (DE); Gunter Grube, Aurachtal (DE); Stefan Gerstner, Obermichelbach (DE); Norbert Radinger, Nurnberg (DE)

Correspondence Address: HEDMAN & COSTIGAN P.C., 1185 AVENUE OF THE AMERICAS, NEW YORK, NY, 10036, US

(21) Appl. No.: 10/565,988

(22) PCT Filed: Jun. 23, 2004
(86) PCT No.: PCT/EP04/06757

§ 371 Date: Feb. 16, 2006

(30) Foreign Application Priority Data
Jul. 25, 2003 (DE) 103 33 875.6

(51) Int. Cl. F16C 33/58

(52) U.S. Cl. 384/569

(57) ABSTRACT

The invention relates to thin-walled rolling bearings, such as needle bearings, which are produced without the removal of material and the outer rings of which form a structural unit and are produced from a cold-rolled strip. According to the invention, the outer rings are produced from a cold-formable, fully hardenable steel, a ratio of from 1:20 to 1:5 being set between their wall thickness and the diameter of the bearing needles, and the fully hardened wall having a core hardness of ≧600 HV and a surface hardness of ≧680 HV. The invention makes it possible for bearings to withstand higher static bearings than bearings made from conventional steels while taking up the same installation space.

### FIELD OF THE INVENTION

The invention relates to thin-walled rolling bearings, such as needle bearings, which are produced without the removal of material and the outer rings of which are produced from a cold-rolled strip. The invention also relates to a universal joint bush for receiving a bearing pin which is mounted in rolling bearing form and is likewise produced from a cold-rolled strip.

### BACKGROUND OF THE INVENTION

Cold-rolled steel strip is in widespread use for the production of cold-formed products. The increase in demands with regard to application and use properties require better mechanical and in particular forming properties. Good forming properties are characterized by r values, characterizing the deep-drawing properties, which are as high as possible, high n values, which characterize the stretch-forming properties, and high-strain coefficients, which characterize the plane strain properties. It has in this context proven advantageous if the forming properties are as equal as possible in the various directions, in particular in the longitudinal, transverse and diagonal directions, i.e. are substantially isotropic. The advantages of isotropic properties manifest themselves mainly in a uniform flow of material and in a reduction in sheet-metal scrap (DE 195 47 181 C1).

In this context, a person skilled in the art will be aware that what are known as envelope circle bearings, such as needle bearings or needle bushes, constitute a particular form of rolling bearing technology, which is delimited from solid rolling bearings of radial design. These envelope circle bearings acquire their roundness and shape by being pressed into a hole, and the sleeve material is therefore subject to permanent compressive stresses. These compressive stresses generated by the operation of pressing into a hole are in addition to the load stresses which occur when the bearing is operating, and consequently the material used has to satisfy high demands. In particular, it needs to have good forming properties and to be suitable for a heat treatment in order to achieve the desired mechanical characteristics.

DE 10 34 932 has described a process for producing a needle bearing in which the running sleeve is first of all produced with a fixed flange, and a cage with a rolling body is introduced into this open sleeve before a captive assembly is formed by bending over the second flange. Then, sleeve and cage are subjected to a common hardening operation. According to this prior art, thin-walled outer and inner rings for needle bearings are produced without removal of material from a cold-rolled strip which is suitable for deep-drawing, the cold-rolled strip being a case-hardening steel, for example of types CK 15, St4 C22, 15Cr3 or 16MnCr5. A precondition for this production process is that the cold-rolled strip has a uniform isotropic formability. In individual or multiple steps in succession, the parts are stretched from the strip of defined thickness, calibrated to a high dimensional accuracy and shaped in such a way as to maintain the same wall thickness. To achieve a resistance to wear and the required load-bearing capacity, these parts which have been formed are case-hardened. This is done by carburizing without or with the addition of nitrogen (carbonitriding) in what are known as case-hardening furnaces at temperatures between 830 and 930° C. Depending on the case depth required, this means a heat treatment of up to two hours and more.

The steels mentioned are considered standard materials for thin-walled outer rings of the needle sleeves or needle bushes produced without removal of material, and have the characteristic properties listed below:
their purity and cold-drawing properties
the required case hardening
the relative change in dimensions and shape during the heat treatment
the required material thickness, based on the case depth Eht and the soft core required for these materials.

The maximum load-bearing capacity of sleeve bearings which have been case-hardened in this way is dependent on the rolling body diameter and the case depth (Eht) which results from the comparative stress. Accordingly, when seen in cross section, case-hardened parts comprise two hardened surface layers and a core zone with a considerably lower hardness. The ratio of the sleeve wall thickness to the case depth is approximately 3:1 to 4:1. The case depth is approximately 5 to 7% of the rolling body diameter plus the required manufacturing tolerance, and consequently the sleeve wall thickness, at its maximum load design, corresponds to more than a quarter of the rolling body diameter.

In the context of the invention, universal joints are also of interest. These are used to connect two shafts at movable angles while at the same time transmitting torques. The connection is in this case brought about in such a manner that in each case two opposite pins of a universal joint engage in corresponding holes in the fork-like ends of the two shafts. To achieve a high freedom of mobility, the pins are accommodated in special bearings, preferably in rolling bearings. The universal joint bushes belonging to the bearing arrangement, which in functional use have to be able to absorb axially acting pin forces via the bush base, are subject to high spring stresses, i.e. the bushes which have been pressed in prestressed form into the universal joint exhibit a certain fatigue if they are made from conventionally case-hardened steel, such as St4, DC04 or C15M in the case of 16MnCr5. The production of a universal joint bush from case-hardened steel is disclosed by DE-B1 021211. The consequence of this fatigue is that the functioning of the overall system becomes inexact on account of increased play after a certain duration of stressing. There is no need for further explanations of universal joint bearing arrangements at this point, since they are well known to the person skilled in the art (DE 21 22 575, DE 30 33 445 A1, DE A 21 20 569, DE 37 39 718 A1).

### SUMMARY OF THE INVENTION

Therefore, it is an object of the invention to provide thin-walled rolling bearings and universal joint bushes produced without removal of material, which are distinguished by an improved efficiency.

According to the invention, this object is achieved, as per the characterizing clause of claim 1 in conjunction with its preamble, by virtue of the fact that the outer rings are produced from a cold-formable, fully hardenable steel, a ratio of from 1:20 to 1:5 being set between their wall thickness and the diameter of the bearing needles, and the fully hardened wall having a core hardness of ≧600 HV and a surface hardness of ≧680 HV.

The main advantage of the thin-walled rolling bearings designed in accordance with the invention is that the required thickness of the outer rings now no longer has to be considered as a material composite made up of core zone and double case depth, but rather can be considered as a virtually homogenous “hardened surface zone”, which is supported by a housing into which the outer ring has been pressed. Since the ratio of case depth to rolling body diameter is crucial for the load-bearing capacity of a bearing, completely different design and installation options result. It is now possible to newly design thin-walled rolling bearings which
can withstand higher static loads while taking up the same installation space,
allow the use of smaller installation spaces while withstanding the same stresses,
allow designs which lead to longer service lives while requiring the same installation space.

Another advantage of the solution according to the invention is that a further potential saving can be achieved on account of the different heat treatment.

Firstly, it is possible to reduce the hardening time, and secondly it is possible to reduce the hardening temperature. The higher dimensional stability of the claimed solution is another advantage.

Further advantageous embodiments of the invention are described in subclaims 2 and 3.

For example, according to claim 2 it is provided that the core hardness is from 600 to 650 HV and the surface hardness is from 680 to 750 HV.

Claim 3 reveals that the heat-treatment steel has the following chemical composition:

0.37-0.50% C
up to 0.40% Si
0.50-0.80% Mn
up to 0.020% P
up to 0.020% S
up to 0.50% Cr
up to 0.40% Ni
up to 0.10% Mo
up to 0.20% Cu

According to the second independent claim, claim 4, it is provided that the universal joint bush is produced from a cold-formable, fully hardenable steel, the fully hardened wall having a core hardness of ≧600 HV and a surface hardness of ≧680 HV.

According to claim 5, the core hardness should advantageously be from 600-650 HV, and the surface hardness should advantageously be from 680-750 HV.

Finally, according to claim 6 it is provided that a heat-treatment steel having the following chemical composition is used for the universal joint bush:

0.37-0.50% C
up to 0.40% Si
0.50-0.80% Mn
up to 0.020% P
up to 0.020% S
up to 0.50% Cr
up to 0.40% Ni
up to 0.10% Mo
up to 0.20% Cu

The advantages of a universal joint bush produced in accordance with the invention are in particular that a higher stiffness of the universal joint system, a higher spring characteristic and a higher breaking strength of the bush base are achieved. The bush base is supported by means of the radial stresses produced by the pressed-in state and acts as a cup spring, the prestressing force of which is maintained throughout the entire service life, since the material of the heat-treatment steel retains the spring properties and a high yield strength all the way into the core.

The invention is explained in more detail on the basis of exemplary embodiments described below.

### BRIEF DESCRIPTION OF THE DRAWINGS

In the drawings:

FIG. 1 shows a perspective view of a needle bush, partially in section,

FIG. 1a shows a longitudinal section through in each case a needle sleeve,

FIG. 1b shows a longitudinal section through in each case a roll sleeve,

FIG. 2 shows a hardness comparison between conventional material and steel according to the invention,

FIG. 3 shows spring characteristics of a bush base made from conventional material and steel according to the invention, and

FIG. 4 shows plastic deformation under radial load of a comparison between conventional material and steel according to the invention.

### DETAILED DESCRIPTION OF THE DRAWINGS

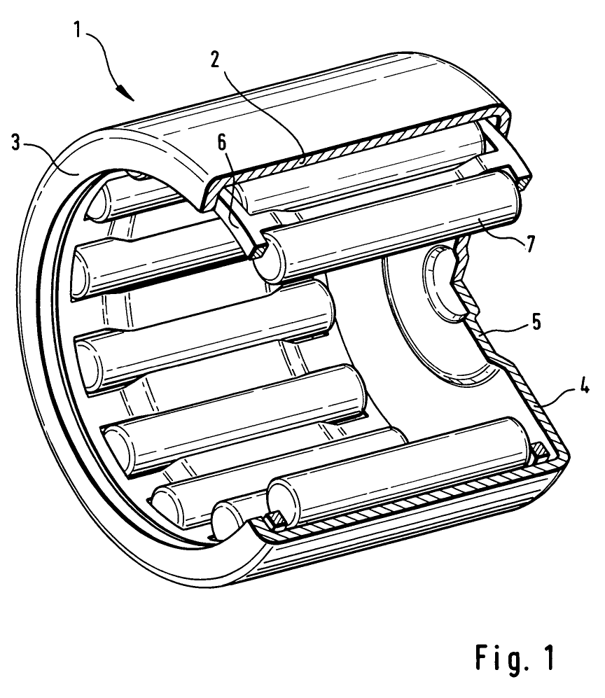

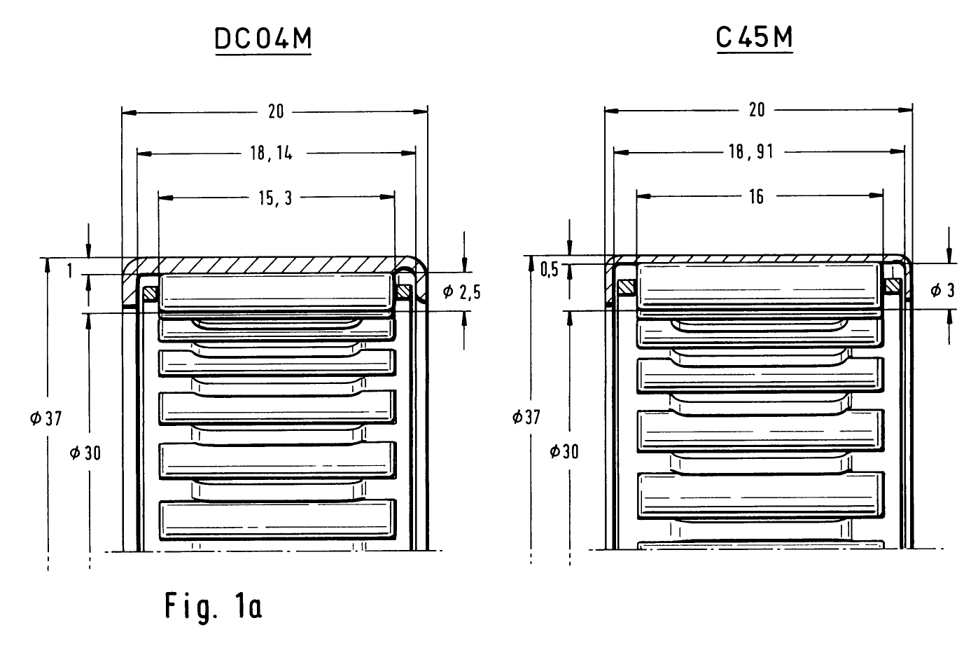

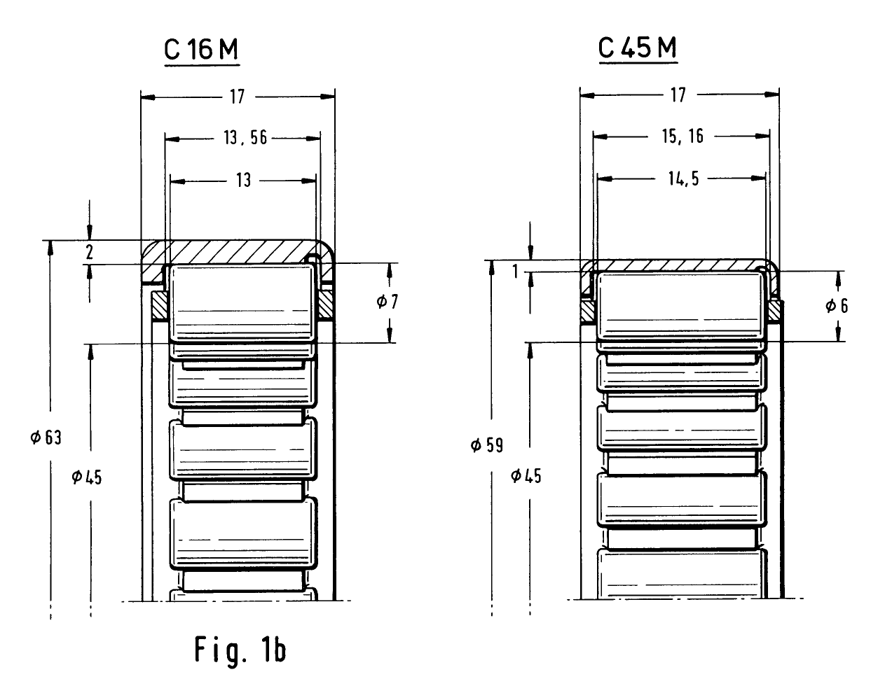

The needle bush which is shown in FIG. 1 and denoted by 1 has a radial portion 2 with an annular profile, which at one end merges into the radially inwardly directed flange 3 and at the other end is closed off by the base 4. Bearing needles 7 which are guided in the cage 6 are mounted so as to be able to roll between the base 4, provided with the elevation 5, and the flange 3. Needle bushes of this type close off bearing positions at ends of shafts.

If a needle bush 1 of this type is now produced in one instance from a steel of type DC04M, in accordance with the prior art, and in one instance from a cold-formable and fully hardenable steel according to the invention, as described in the claims, with the same external diameter, the new design according to the invention approximately gives the following potential savings:
the wall thickness of the needle bush can be reduced by up to 50%
the diameter of the rolling bodies can be increased by up to 20%
the axial extent of the rolling bodies can be extended by up to 5%
the dynamic load-bearing coefficient Cr can be increased by up to 18%
the static load-bearing coefficient Cor can be increased by up to 9%
the dynamic service life can be increased by up to 75%
the total weight can be reduced by up to 7%.

As a specific comparison of the needle sleeves of type HK 3020 diagrammatically depicted in FIG. 1a demonstrates, both the needle sleeve made from the case-hardening steel DC04M (0.05-0.08% C) and the needle sleeve made from the steel C45M according to the invention (0.37-0.50% C) have the same dimensions, as follows:
External diameter 37 mm
Envelope circle diameter 30 mm
Axial extent 20 mm

The differences between the two needle sleeves are determined by the geometric dimensions below:
Whereas from the left-hand needle sleeve according to the previous prior art, a wall thickness of 1 mm has been required, for the right-hand needle sleeve according to the invention this wall thickness is reduced to 0.5 mm.
The diameter of the bearing needles is given as 2.5 or 3 mm, respectively, giving a ratio of wall thickness to diameter of the bearing needles of 1:2.5 and 1:6 respectively.
The axial length of the bearing needles is 15.3 and 16 mm, respectively.
The internal distance from flange to flange is 18.14 and 18.91 mm, respectively.

It can be seen that for the same installation conditions (same external diameter, same envelope circle diameter, same axial extent), the load-bearing capacity is increased on account of the greater diameter of the bearing needles and their greater axial extent.

The roll sleeves illustrated in FIG. 1b reveal a similar picture with regard to the potential savings that can be achieved. The left-hand roll sleeve designed in accordance with the prior art is made from case-hardening steel C16M containing 0.145-0.194% C, while the right-hand roll sleeve in accordance with the invention is made from steel grade C45M; Both parts have the same dimensions given below:
Envelope circle diameter 45 mm
Axial extent 17 mm

The differences between the two roll sleeves are determined by the following geometric dimensions:
As in Example 1a, the wall thickness is reduced by 50%, specifically from 2 mm on the left-hand side to 1 mm on the right-hand side.
The diameter of the roll bodies is given as 7 and 6 mm, respectively, resulting in a ratio of wall thickness to diameter of the roll bodies of 1:3.5 and 1:6, respectively.
The axial length of the roll bodies is 13 and 14.5 mm, respectively.
The internal distance from flange to flange of the roll sleeve is given as 13.56 and 15.16 mm, respectively.
The external diameter is reduced from 63 to 59 mm.

In this case, the potential saving between the two roll sleeves is realized by a reduced installation space (external diameter) while still achieving the same load-bearing capacity.

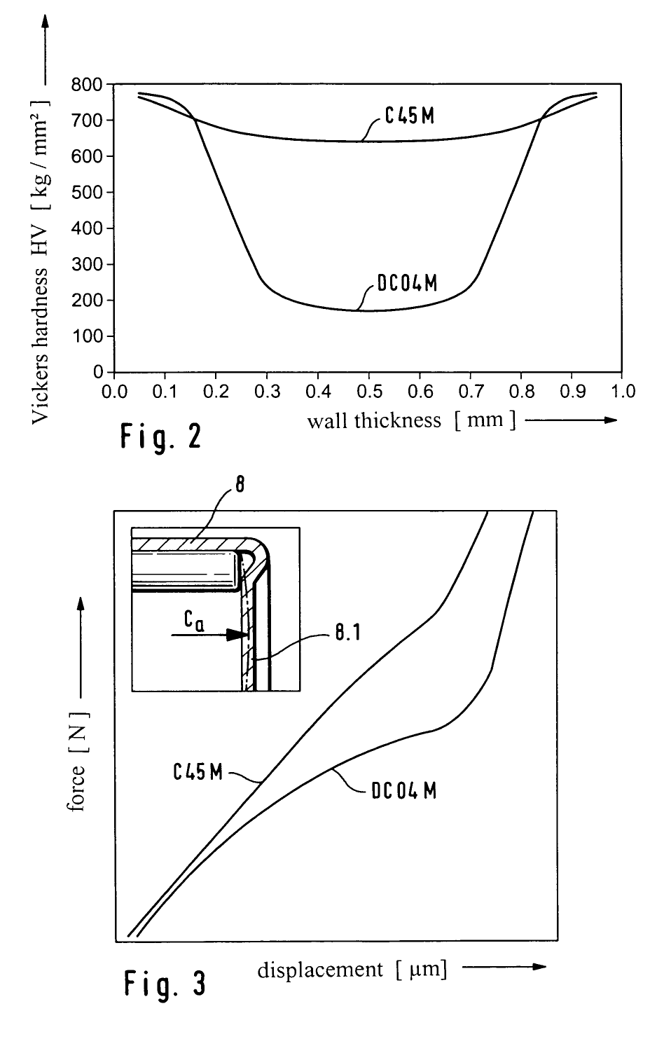

As shown in FIG. 2, the steel C45M according to the invention, unlike the conventional steel of type DC04M, has a hardness profile which decreases only slightly in the direction of the center of the strip. Whereas the surface hardness can be set at approximately 750 HV, the core hardness reaches a value of approximately 650 HV. This optimized hardenability, which can be adapted to the component geometry and the stresses, means that the steel has a high core hardness, toughness and elasticity. This high core hardness of the cold-formable, fully hardenable steel ultimately ensures that the potential savings described above, such as a reduction in the wall thickness, an increase in the rolling body diameter, an increase in the dynamic and static load-bearing coefficient, an increase in the dynamic service life and a reduction in the total weight, are possible. The steel of type C45M is an isotropic fine-grained steel with a high purity which is specifically adapted to the requirements of rolling bearing technology. Its deep-drawing properties and formability are comparable to the cold-rolled strip materials that have been used hitherto, but its hardenability is greatly superior to that of the conventional steels.

The spring characteristics of the base 8.1 of universal joint bushes 8 made from DC04M and C45M illustrated in FIG. 3 clearly demonstrate that in the case of a bush base 8.1 made from DC04M, plastic deformation occurs beyond a certain force, whereas the base 8.1 of a bush made from C45M retains its elastic properties over a significantly wider force range. In the context of the invention, the bush base 8.1 acts as a cup spring, the prestressing force of which is maintained throughout the entire service life, since the material of the heat-treatment steel according to the invention has spring properties all the way into the core zone. The prestressing force of a universal joint bush 8 according to the invention, with the same geometric dimensions, increases by at least 20% compared to a universal joint bush according to the prior art. It is in this way possible to achieve a higher stiffness of the universal joint system as a whole, which is of benefit to the function and service life thereof. In the case of the prior art bushes pressed into the universal joint, fatigue phenomena occur if these bushes are made from conventionally case-hardened steels, with the result that these universal joints, for example when used in a steering column or a drive system, have a greater play after a certain stressing time, which considerably impairs their functioning.

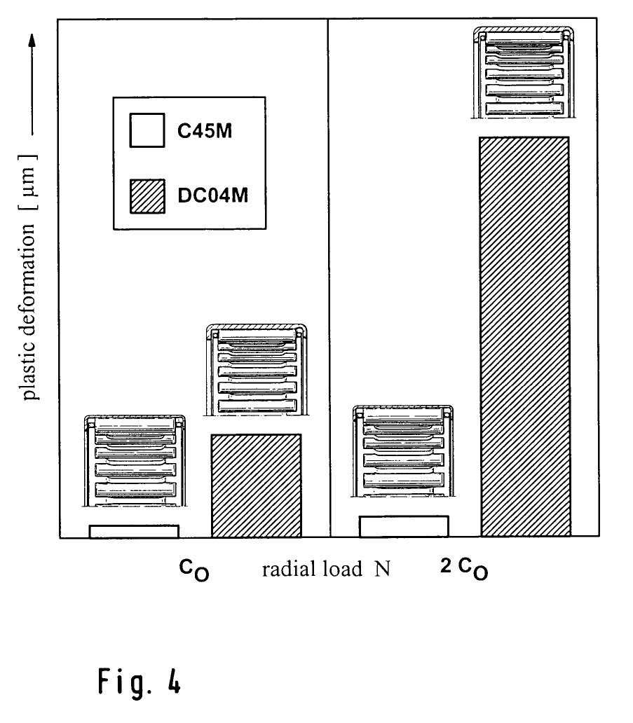

Finally, FIG. 4 shows the different plastic deformation of sleeve races made from DC04M and C45M under stress. The bearings made from the new material have a higher static and dynamic load-bearing capacity, on account of the high core hardness, than similar bearings made from conventional steel. This reduces plastic deformation at the races under high static stresses.

### LIST OF DESIGNATIONS

1 Needle bush
2 Radial portion
3 Flange
4 Base
5 Elevation
6 Cage
7 Bearing needle
8 Universal joint bush
8.1 Base

1. A thin-walled rolling bearing, such as a needle bearing, produced without removal of material, the outer rings of which bearing are produced from a cold-rolled strip, characterized in that the outer rings are produced from a cold-formable, fully hardenable steel, a ratio of from 1:20 to 1:5 being set between their wall thickness and the diameter of the bearing needles, and the fully hardened wall having a core hardness of ≧600 HV and a surface hardness of ≧680 HV.

2. The rolling bearing as claimed in claim 1, characterized in that the core hardness is from 600-650 HV and the surface hardness is from 680-750 HV.

3. The rolling bearing as claimed in claim 1, characterized in that a heat-treatment steel with the following chemical composition is used:
0.37-0.50% C
up to 0.40% Si
0.50-0.80% Mn
up to 0.020% P
up to 0.020% S
up to 0.50% Cr
up to 0.40% Ni
up to 0.10% Mo
up to 0.20% Cu

4. A universal joint bush (8) for receiving a bearing pin which is mounted in rolling bearing form and is formed from a cold strip as a thin-walled needle bearing bush which is produced without the removal of material and the closed base of which is used for a universal joint pin to bear against at the end side, characterized in that it is produced from a cold-formable, fully hardenable steel, the fully hardened wall having a core hardness of ≧600 HV and a surface hardness of ≧680 HV.

5. The universal joint bush (8) as claimed in claim 4, characterized in that the core hardness is from 600-650 HV and the surface hardness is from 680-750 HV.

6. The universal joint bush (8) as claimed in claim 4, characterized in that a heat-treatment steel with the following chemical composition is used:
0.37-0.50% C
up to 0.40% Si
0.50-0.80% Mn
up to 0.020% P
up to 0.020% S
up to 0.50% Cr
up to 0.40% Ni
up to 0.10% Mo
up to 0.20% Cu
